(19) United States
(12) Patent Application Publication
(10) Pub. No.: US 2016/0298863 A1
(43) Pub. Date: Oct. 13, 2016

(54) Air Purification Device With Ozone And Fine Dust Cleaning

(71) Applicant: MENTUS HOLDING AG, Cham (CH)

(72) Inventor: Adrian Peterhans, Niederrohrdorf (CH)

(21) Appl. No.: 15/023,302

(22) PCT Filed: Oct. 1, 2014
(86) PCT No.: PCT/EP2014/071059

§ 371 Date: Mar. 18, 2016

(30) Foreign Application Priority Data
Oct. 1, 2013 (CH) 01687/13

(51) Int. Cl. F24F 3/16; B03C 3/014; F24F 11/00; B03C 3/36; F24F 3/14; F24F 5/00; B03C 3/017; B03C 3/019

(52) U.S. Cl. CPC F24F 3/1603; B03C 3/017; B03C 3/014; B03C 3/019; B03C 3/36; F24F 3/166; F24F 3/14; F24F 5/0042; F24F 11/0079; B03C 2201/24; F24F 2003/1625; F24F 2003/1635; F24F 2003/165; F24F 2003/1685; Y02B 30/746; F24F 2011/0026

(57) ABSTRACT

An air purification device with ozone and find dust cleaning, and optionally heating, cooling and dehumidifying function, is formed for installation in a room of a building. The air purification device comprises a first air channel to supply fresh air and a second air channel to discharge extract air. The two air channels lead through a heat exchanger. The air purification device further comprises a third air channel which opens into the first air channel after the heat exchanger. An electric filter/ozone generator is arranged in the first air channel after the first inlet and in the third air channel after the third inlet. A first fan is arranged in the first air channel after the electric filter/ozone generator and a second fan is arranged before the active carbon filter. A control unit is programmed to operate in at least one first operating mode the second fan with a higher suction power than the first fan.

### TECHNICAL FIELD

The invention relates to an air purification device with ozone and fine dust cleaning, which is installed in a room and is connected via two lines to the exterior side of the building in order to supply fresh air from the outside and to discharge extract air to the ambient environment. The invention further relates to an air purification device which is additionally formed with a heating, cooling and optionally dehumidifying function.

### BACKGROUND OF THE INVENTION

Numerous air purification devices and air-conditioning devices are known. Many of these devices are configured for purifying and conditioning the air of an entire building. The air is frequently conditioned in a central unit in buildings and is conducted via ventilation pipes to the individual rooms. Many split devices are also known in which a cooling unit is mounted in the room, compressors and the like for supplying the cooling unit with cold are installed outside of the building. Such air-conditioning devices come with the disadvantage that microorganisms of all kinds accumulate in the ventilation channels and the electric filters which are installed for cleaning the air from dust and fine dust show poor efficiency because the air flows with a relatively high flow velocity through the electric filters. Therefore, the cleaning of fine dust does usually not meet the necessary requirements.

### SHORT DESCRIPTION OF THE INVENTION

The invention is based on the object of developing an air purification device which purifies the air in an efficient manner.

The invention relates to an air purification device, which is formed for installation in a room of a building and for cleaning the air of the room, comprising

a first inlet, a second inlet, a third inlet, a first outlet and a second outlet, wherein the first inlet and the second outlet can be connected to conduits which lead to the exterior side of the building, and the first outlet, the second inlet and the third inlet open into the room,

a first air channel, which connects the first inlet to the first outlet,

a second air channel, which connects the second inlet to the second outlet,

a first electric filter/ozone generator, which is arranged in the first air channel after the first inlet,

an active carbon filter, which is arranged before the first outlet in the first air channel,

a heat exchanger, which is arranged to exchange heat between the first air channel and the second air channel,

a first fan, which is arranged in the first air channel in the direction of flow after the electric filter/ozone generator,

a second fan, which is arranged in the first air channel before the active carbon filter,

a third fan, which is arranged in the second air channel,

a third air channel, which leads from the third inlet to the first air channel and opens into the first air channel at a point which lies after the heat exchanger and before the second fan,

a second electric filter/ozone generator, which is arranged after the third inlet in the third air channel,

a control unit, which is programmed, in at least one first operating mode, to operate the second fan with a higher suction power than the first fan in order to produce suction in the first air channel between the second fan and the first fan, which suction sucks outdoor air sucked by the first fan from the ambient environment of the building and conveyed into the first air channel in the direction toward the active carbon filter on the one hand, and which sucks air from the room into the third air channel and from there further into the first air channel and in the direction toward the active carbon filter on the other hand

The high voltage applied to the electric filters/ozone generators is preferably controlled dependent on the velocity of the air, in order to achieve a constant fine dust filtering at minimal energy consumption.

The air purification device according to the invention can be expanded to a room air conditioner with additional heating, cooling and, optionally, dehumidifying function. Such an air purification device further comprises:

a pipe which carries water in operation and which is connectable to a basic system in order to integrate the air purification device into a heating/cooling circuit,

several Peltier elements, whose one side is in thermal contact with the pipe connected to the water-carrying basic system and whose second side is in thermal contact with cooling fins which protrude into the first air channel, wherein the control unit is programmed to trigger, in a heating mode, a first or a first group of the Peltier elements for pumping heat from the water-carrying pipe into the first air channel, and to trigger, in a cooling mode, the first or the first group of the Peltier elements for pumping heat from the first air channel to the water-carrying pipe.

The control unit can further be programmed to trigger a second or a second group of the Peltier elements for cooling the connected cooling fins beneath the dew point of the air passing by.

The air purification device can further comprise a CO₂ sensor and the control unit be programmed to control the speed of the first fan and the speed of the second fan according to an output signal of the CO₂ sensor.

The air purification device can further comprise a humidity sensor and the control unit be programmed to control the speed of the first fan and the speed of the second fan according to an output signal of the humidity sensor.

The if the air purification device comprises the CO₂ sensor and the humidity sensor, then the control unit is programmed to control the speed of the first fan and the speed of the second fan according to an output signal of the humidity sensor and an output signal of the CO₂ sensor.

The rotational speed of the first fan is larger than the rotational speed of the second fan. The speed of the third fan can also be increased in order to discharge the same amount of extract air as fresh air is supplied. This control makes it possible to increase the amount of fresh air that is supplied to the room, and, accordingly, discharge more extract air and thus undesirable CO₂ or unwanted moisture out of the room.

### DESCRIPTION OF THE DRAWING FIGURES

The invention is subsequently described in further detail by means of embodiments and the drawing. The figures are schematically drawn.

FIG. 1 shows a diagram of an air purification device in accordance with the invention, and

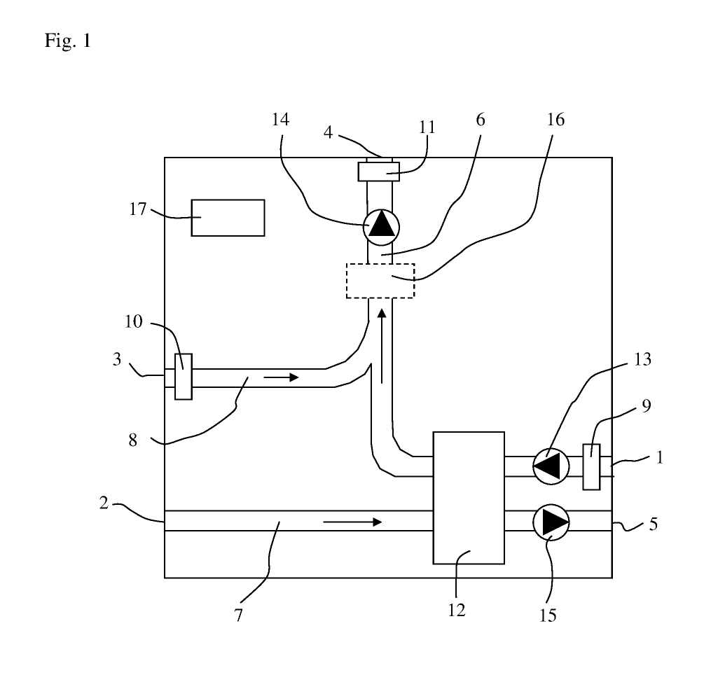

FIG. 2 shows a diagram of an air purification device in accordance with the invention with additional heating, cooling and dehumidifying function.

### DETAILED DESCRIPTION OF THE INVENTION

FIG. 7 shows a diagram of an air purification device in accordance with the invention, which is formed for installation in a room of a building and for cleaning of the air of the room. The air purification device comprises comprises a first inlet 1, a second inlet 2, a third inlet 3, a first outlet 4 and a second outlet 5. The air purification device is connected via two conduits to the exterior side of the building: a first line (not shown) connects the first inlet 1 to the exterior side of the building, a second line (not shown) connects the second outlet 5 to the exterior side of the building. The first outlet 4, the second inlet 2 and the third inlet 3 open into the room, preferably at spatially separated points. The air purification device further comprises a first air channel 6, a second air channel 7 and a third air channel 8. The direction of flow of the air in the air channels 6 to 8 is represented by arrows. The first air channel 6 connects the first inlet 1 to the first outlet 4. The second air channel 7 connects the second inlet 2 to the second outlet 5. The third air channel 8 leads from the third inlet 3 to the first air channel 6. A first electric filter/ozone generator 9 is arranged after the first inlet 1, i.e. in the direction of flow after the first inlet 1, in the first air channel 6 and a second electric filter/ozone generator 10 is arranged after the third inlet 3, i.e. in the direction of flow after the third inlet 3, in the third air channel 8. An active carbon filter 11 is arranged in the first air channel 6 before the first outlet 4. The first air channel 6 and the second air channel 7 are guided through a heat exchanger 12 in order to exchange heat between the first air channel 6 and the second air channel 7. A first fan 13 is arranged in the first air channel 6 in the direction of flow after the first electric filter/ozone generator 9, a second fan 14 is arranged in the first air channel 6 in the direction of flow before the active carbon filter 11, and a third fan 15 is arranged in the second air channel 7 in the direction of flow after the heat exchanger 12. The third air channel 8 leads from the third inlet 3 to the first air channel 6 and opens into the first air channel 6 at a point which lies after the heat exchanger 12 and before the second fan 14. The first air channel 6 is thus subdivided into two sections, namely a first section which leads from the first inlet 1 to the point at which the third air channel 8 opens into the first air channel 6, and a second section which leads from this point to the first outlet 4. Only fresh air flows in the first section. Fresh air and recirculation air flow in the second section. A coarse filter can be arranged at each inlet.

A humidifying module 16 can optionally be installed in the second section of the first air channel 6 before or after the second fan 14. The optional humidifying module 16 is preferably equipped with a water tank that can be refilled by hand, but it can also be formed to be connectable to a water pipe.

Since the air purification device is designed for installation in a room and therefore only needs to ensure good air quality in one single room, the need for fresh air is much lower than if the air purification device were designed for supplying an entire apartment or a building with purified air. The air purification device is thus designed for an upper limit of fresh air which typically lies at approximately 60 m³ per hour. This leads to a relatively low flow velocity of the air in the air purification device.

The air purification device further comprises a control unit 17. The control unit 17 is set up to operate the air purification device in at least one first operating mode, preferably in several operating modes. They will be explained below in closer detail.

### Operating Mode 1

The first operating mode is used to bring fresh air into the room and to remove used air from the room, and to again purify a fraction of the air in the room. The control unit 17 is programmed to operate the second fan 14 in this operating mode always at a higher suction power than the first fan 13. The second fan 14 thus produces suction in the first air channel 6 which sucks the air sucked by the first fan 13 from the ambient environment of the building and conveyed into the first channel 6 in the direction toward the active carbon filter 11. Said suction firstly leads to the consequence that the ozone generated by the first electric filter/ozone generator 9 flows to the active carbon filter 11 where it is destroyed, and that no ozone flows into the third air channel 8 and reaches the room through the third inlet 3. Said suction secondly leads to the consequence that air is sucked from the room into the third air channel 8 and from there further into the first air channel 6. The air sucked from the room is purified in the second electric filter/ozone generator 10 from dust, especially fine dust, and the like and is enriched with ozone. The air sucked from the room and the sucked outdoor air are joined, relieved of ozone in the active carbon filter 11 again and conveyed into the room. The room is thus supplied with a fraction of fresh air and a fraction of recirculation air.

The greater the difference between suction power of the second fan 14 and the suction power of the first fan 13, the greater the fraction of recirculation air in relation to fresh air. The recirculation air is relieved upon entry into the third air channel 8 in the second electric filter 10 from dust, fine dust, and pollen, and is enriched with ozone. The ozone present everywhere in the third channel 8 and in the first air channel 6 destroys the microorganisms contained in the recirculation air such as bacteria, parasites, funghi, protozoa, viruses etc.

The control unit 17 further operates the third fan 15 with a suction power which typically approximately corresponds to the suction power of the first fan 13 in order to convey approximately the same quantity of room air to the outside as fresh air is conveyed by means of the first fan 13 into the room. The heat or cold contained in the room air is discharged to the fresh air in the heat exchanger 12.

### Operating Mode 2

The control unit 17 operates the first fan 13 and the second fan 14 as in the operating mode 1, while the third fan 15 is switched off. Since virtually no air is discharged via the second air channel 17, a fraction of the air in the room seeks different ways to the outside and escapes via cracks in the windows and doors. Since virtually no extract air flows through the heat exchanger 12, no exchange of heat occurs in the heat exchanger 12. If the supplied fresh air is colder than the air in the room, the temperature of the air in the room decreases. If the supplied fresh air is warmer than the air in the room, the temperature of the air in the room increases.

### Operating Mode 3

The control unit 17 only operates the second fan 14. The first fan 13 and the third fan 15 are switched off This operating mode is used to purify the air in the room without supplying fresh air.

In all operating modes the suction power of the second fan 14 is greater than the suction power of the first fan 13. (This is obviously the case when the first fan 13 is switched off).

If the optional humidifying module 16 is installed in the first air channel 6, further operating modes are possible in which the air is humidified before the exit from the first air channel 6.

The air purification device in accordance with the invention offers a number of special advantages, which include the following:
The electric filters/ozone generators operate with high efficiency, because with a maximum of 60 m³ per hour the air flow is relatively low, so that the air has a sufficiently long dwell time in the electric filter/ozone generator.
The room air has a high degree of purity because fine dust is effectively removed from the air and microorganisms of all types are destroyed by the ozone. This applies both to the fresh air and also to the recirculation air. This even leads to the consequence that the extract air removed from the room is cleaner than the air in the ambient environment of the building.
The ozone, which also includes the ozone that is supplied from the outside with the fresh air, is fully eliminated, so that the air supplied to the room is virtually free from ozone.
The fresh air and the recirculation air can be joined in the same air channel without ozone reaching the room. This reduces the number of the pipes and channels required for air guidance, thus considerably simplifying air guidance.
The exchange of heat in the heat exchanger 12 can be prevented without the use of flaps or a bypass circumventing the heat exchanger 12, namely by deactivating the third fan 15.
Since the electric filters/ozone generators 9 and 10 are directly arranged after the first inlet 1 or third inlet 3 and the active carbon filter 11 directly before the first outlet 4, the three air channels 6 to 8 are always enriched with ozone in operation, so that microorganisms reaching the air channels such as bacteria, parasites, fungi, protozoa, viruses etc are immediately destroyed. The suction that permanently prevails in the first air channel 6 and in the third air channel 8 ensures that no ozone flows into the third air channel 8 and reaches the room through the third inlet 3.

The electric filters/ozone generators 9 and 10 have a discharge electrode and at least one precipitation electrode. The high voltage applied to the discharge electrode is advantageously controlled or regulated depending on the air velocity. In this manner, constant fine dust filtering is achieved with minimal energy consumption.

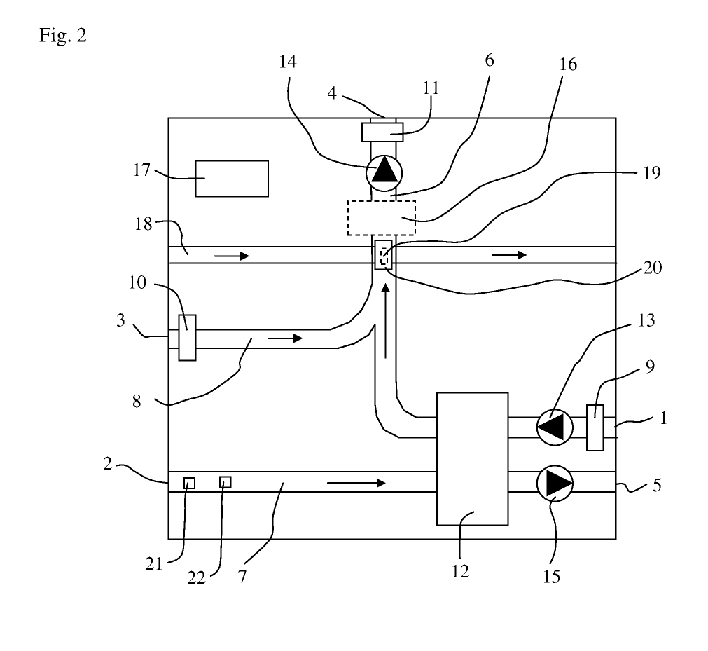

FIG. 2 shows a diagram of an air-conditioning device in accordance with the invention, which can additionally be connected to a water-carrying basic system and is formed with Peltier elements for heating, cooling and optionally dehumidifying the air supplied to the room, which therefore can also be designated as a room-air conditioning device. The air purification device additionally comprises a pipe 18 carrying water in operation, which pipe can be connected to a basic system in order to integrate the air purification device into a heating/cooling circuit and to supply it with tempered water, and several Peltier elements 19, whose one side is in thermal contact with the pipe 18 connected to the water-carrying basic system and whose other side is in thermal contact with cooling fins 20 which protrude into the first air channel The cooling fins 20 connected to the Peltier elements 19 are located in the first air channel 6, preferably (as shown) in the direction of flow of the air after the point where the third air channel 8 opens into the first air channel 6. The control unit 17 is additionally programmed in order to trigger in a first heating mode a first or a first group of the Peltier elements 19 for pumping heat from the water-carrying pipe 18 into the first air channel 6 and in a cooling mode to trigger the first or the first group of the Peltier elements 19 for pumping heat from the first air channel 6 to the water-carrying pipe 18. The basic system contains a central device which is set up to heat the water circulating in the heating/cooling circuit and to optionally also cool said water according to the demand. The control unit 17 is preferably also programmed to indicate to the basic system the temperature which the water circulating in the heating/cooling circuit should have.

The control unit 17 can additionally be programmed to trigger a second or a second group of the Peltier elements 19 for cooling the connected cooling fins 20 beneath the dew point of the air passing by in order to dehumidify the air passing by. This type of dehumidifying also produces cooling of the air. If cooling is undesired, the first or the first group of the Peltier elements 19 can be used for heating the air again.

The air purification device can further comprise a CO₂ sensor 21, which is advantageously arranged in the second air channel 7. The control unit 17 is then advantageously programmed to control the speed of the first fan 13 and the speed of the second fan 14 according to an output signal of the CO₂ sensor 21. The speed of at least the two fans 13 and 14, and advantageously the speed of all three fans 13 to 15, is increased, wherein the speed of the first fan 13 remains higher than the speed of the second fan 14 in order to increase the fraction of fresh air which is supplied to the room, and to accordingly remove more extract air from the room. This control leads to the consequence that the CO₂ concentration in the room decreases. This allows an energy-efficient conditioning of the room air dependent on the demand.

The air purification device can further comprise a humidity sensor 22, which is advantageously arranged in the second air channel 7. The control unit 17 is then advantageously programmed to control the speed of the first fan 13 and the speed of the second fan 14 according to an output signal of the humidity sensor 22 and/or the output signal of the CO₂ sensor 21. The speed of at least one of the two fans 13 and 14, and advantageously all three fans 13 to 15, is increased, wherein the speed of the first fan 13 remains higher than the speed of the second fan 14 in order to increase the fraction of fresh air which is supplied to the room and to accordingly remove more extract air and thus undesirable CO₂ and undesirable humidity from the room. The speed of the third fan 15 can also be increased in order to remove the same quantity of extract air as fresh air is supplied.

The air purification device described by reference to FIG. 2 allows the energy-efficient, user-dependent conditioning of room air, in which the five relevant room-air quality parameters temperature, humidity, CO₂ concentration, ozone concentration and fine-dust content of the air are optimised. A device of this kind is not yet available on the market.

While embodiments and applications of this invention have been shown and described, it would be apparent to those skilled in the art that many more modifications than mentioned above are possible without departing from the inventive concept herein. The invention, therefore, is not to be restricted except in the spirit of the appended claims and their equivalents.

1. An air purification device, which is formed for installation in a room of a building and for cleaning the air of the room, comprising
a first inlet, a second inlet, a third inlet, a first outlet and a second outlet, wherein the first inlet and the second outlet can be connected to conduits which lead to the exterior side of the building, and the first outlet, the second inlet and the third inlet open into the room,
a first air channel, which connects the first inlet to the first outlet,
a second air channel, which connects the second inlet to the second outlet,
a first electric filter/ozone generator, which is arranged in the first air channel after the first inlet,
an active carbon filter, which is arranged before the first outlet in the first air channel,
a heat exchanger, which is arranged to exchange heat between the first air channel and the second air channel,
a first fan, which is arranged in the first air channel in the direction of flow after the electric filter/ozone generator,
a second fan, which is arranged in the first air channel before the active carbon filter,
a third fan, which is arranged in the second air channel,
a third air channel, which leads from the third inlet to the first air channel and opens into the first air channel at a point which lies after the heat exchanger and before the second fan,
a second electric filter/ozone generator, which is arranged after the third inlet in the third air channel,
a control unit, which is programmed, in at least one first operating mode, to operate the second fan with a higher suction power than the first fan in order to produce suction in the first air channel between the second fan and the first fan, which suction sucks outdoor air sucked by the first fan from the ambient environment of the building and conveyed into the first air channel in the direction toward the active carbon filter on the one hand, and which sucks air from the room into the third air channel and from there further into the first air channel and in the direction toward the active carbon filter on the other hand.

2. The air purification device according to claim 1, further comprising
a pipe which carries water in operation and which is connectable to a basic system in order to integrate the air purification device into a heating/cooling circuit,
several Peltier elements, whose one side is in thermal contact with the pipe connected to the watercarrying basic system and whose second side is in thermal contact with cooling fins which protrude into the first air channel, wherein the control unit is programmed to trigger, in a heating mode, a first or a first group of the Peltier elements for pumping heat from the watercarrying pipe into the first air channel, and
to trigger, in a cooling mode, the first or the first group of the Peltier elements for pumping heat from the first air channel to the watercarrying pipe.

3. The air purification device according to claim 2, wherein the control unit is programmed to trigger a second or a second group of the Peltier elements for cooling the connected cooling fins beneath the dew point of the air passing by.

4. The air purification device according to claim 1, further comprising a CO₂ sensor, wherein the control unit is programmed to control the speed of the first fan and the speed of the second fan according to an output signal of the CO₂ sensor.

5. The air purification device according to claim 1, further comprising a humidity sensor, wherein the control unit is programmed to control the speed of the first fan and the speed of the second fan according to an output signal of the humidity sensor.

6. The air purification device according to claim 1, wherein the control unit is programmed to control the a high voltage applied to the electric filters/ozone generators dependent on the a velocity of the air passing by.

7. The air purification device according to claim 2, further comprising a CO₂ sensor, wherein the control unit is programmed to control the speed of the first fan and the speed of the second fan according to an output signal of the CO₂ sensor.

8. The air purification device according to claim 2, further comprising a humidity sensor, wherein the control unit is programmed to control the speed of the first fan and the speed of the second fan according to an output signal of the humidity sensor.

9. The air purification device according to claim 2, wherein the control unit is programmed to control a high voltage applied to the electric filters/ozone generators dependent on a velocity of the air passing by.

10. The air purification device according to claim 3, further comprising a CO₂ sensor, wherein the control unit is programmed to control the speed of the first fan and the speed of the second fan according to an output signal of the CO₂ sensor.

11. The air purification device according to claim 3, further comprising a humidity sensor, wherein the control unit is programmed to control the speed of the first fan and the speed of the second fan according to an output signal of the humidity sensor.

12. The air purification device according to claim 3, wherein the control unit is programmed to control a high voltage applied to the electric filters/ozone generators dependent on a velocity of the air passing by.

13. The air purification device according to claim 1, further comprising a CO₂ sensor and a humidity sensor, wherein the control unit is programmed to control the speed of the first fan and the speed of the second fan according to an output signal of the humidity sensor and/or an output signal of the CO₂ sensor.

14. The air purification device according to claim 2, further comprising a CO₂ sensor and a humidity sensor, wherein the control unit is programmed to control the speed of the first fan and the speed of the second fan according to an output signal of the humidity sensor and/or an output signal of the CO₂ sensor.

15. The air purification device according to claim 3, further comprising a CO₂ sensor and a humidity sensor, wherein the control unit is programmed to control the speed of the first fan and the speed of the second fan according to an output signal of the humidity sensor and/or an output signal of the CO₂ sensor.

16. The air purification device according to claim 4, wherein the control unit is programmed to control a high voltage applied to the electric filters/ozone generators dependent on a velocity of the air passing by.

17. The air purification device according to claim 5, wherein the control unit is programmed to control a high voltage applied to the electric filters/ozone generators dependent on a velocity of the air passing by.

18. The air purification device according to claim 7, wherein the control unit is programmed to control a high voltage applied to the electric filters/ozone generators dependent on a velocity of the air passing by.

19. The air purification device according to claim 8, wherein the control unit is programmed to control a high voltage applied to the electric filters/ozone generators dependent on a velocity of the air passing by.

20. The air purification device according to claim 10, wherein the control unit is programmed to control a high voltage applied to the electric filters/ozone generators dependent on a velocity of the air passing by.

21. The air purification device according to claim 11, wherein the control unit is programmed to control a high voltage applied to the electric filters/ozone generators dependent on a velocity of the air passing by.
